(19) United States
(12) Patent Application Publication
(10) Pub. No.: US 2005/0063124 A1
(43) Pub. Date: Mar. 24, 2005

(54) Electrical apparatus and a limiting method

(76) Inventors: Peter Lundberg, Vasteras (SE); Bo Bijlenga, Amal (SE); Falah Al-Hosini, Vasteras (SE); Nicklas Johansson, Uppsala (SE)

Correspondence Address: VENABLE, BAETJER, HOWARD AND CIVILETTI, LLP, P.O. BOX 34385, WASHINGTON, DC, 20043-9998, US

(21) Appl. No.: 10/485,965

(22) PCT Filed: Jul. 4, 2002
(86) PCT No.: PCT/SE02/01331

(30) Foreign Application Priority Data
Aug. 9, 2001 (SE) 0102680-6

(51) Int. Cl. H02H 3/22

(52) U.S. Cl. 361/111

(57) ABSTRACT

An electrical apparatus for limiting the peak voltage across a recttifying member (23) of a current valve arranged in a circuit having a substantial inductance (24) and having at least one controllable semiconductor device (22) and at least one said rectifying member (23) connected in anti-parallel therewith when the rectifying member is turning off, comprises means (28, 29) adapted to control the semiconductor device so as to increase the conductivity thereof during turning off of the rectifying member.

The present invention relates to an electrical apparatus for limiting the peak voltage across a rectifying member of a current valve arranged in a circuit having a substantial inductance and having at least one controllable semiconductor device and at least one said rectifying member connected in anti-parallel therewith when the rectifying member is turning off.

Such a rectifying member is usually, although not necessarily, a diode, so that hereinafter by way of example and for simplification, but not at all by way of limitation, the word diode will be used. Furthermore, the word IGBT will hereinafter by way of example, but not by way of limitation, be used for said controllable semiconductor device.

Furthermore, the invention comprises an electrical apparatus for such a peak voltage limitation across such a diode when it is turning off in all types of circuits having a substantial, i.e. comparatively high, inductance creating a heavy inductive over-voltage when the diode is turning off. It is then primarily a question of converters having an inductor in series with said current valve. The case of a voltage stiff converter having a resonance circuit in the form of so-called ARCP-circuit (Auxiliary Resonant Commutation Pole) will for that sake be described hereinafter so as to exemplify the invention and the problem thereof, but not in any way for restricting the invention.

Such a converter already known is schematically illustrated in the appended FIG. 1. Only the part of the converter, which is connected to one phase of an alternating voltage phase line is shown in this Figure, in which the number of phases is normally three. The converter is a so-called VSC-converter (Voltage Source Converter), which has two so-called main current valves 1, 2 connected in series between the two poles 3, 4, positive and negative, respectively, of a direct voltage side of the apparatus. Capacitors 5, 6 are arranged to define a voltage between the two poles, so that the pole 3 gets the voltage +Ud_{dc} and the pole 4 gets the potential −U_{dc}, in which the point 7 between the capacitors gets the potential 0.

The current valves 1 and 2 are each constituted by a controllable semiconductor device 8, 9, such as an IGBT, MOSFET or BJT, and a rectifying member in the form of a rectifying diode 10, 11 connected in anti-parallel therewith. Furthermore, a so-called snubber capacitor 12, 13 is connected in parallel with the current valve. A midpoint 14, which constitutes the phase output of the converter, is connected to an alternating voltage phase line 15 through an inductor 16.

The converter has also an arrangement 17 to control the different semiconductor devices of the current valves 1 and 2 and thereby ensure that said phase output 14 is connected to and receives the same potential as the pole 3 or the pole 4 so as to generate positive and negative pulses according to a pulse width modulation pattern on the phase output 14. It would here also be possible that the circuit shown in FIG. 1 is a part of a partial circuit in a converter with more possible voltage levels than two on the phase output 14 by the fact that more main current valves are connected in series with the current valves 1, 2. Furthermore, it is pointed out that the arrangement 17 and the connection thereof is very schematically illustrated here, and a separate such arrangement would in the practice be arranged on high potential at each individual current valve 1, 2 and these will receive control signals from a control arrangement arranged on ground level.

The converter has also a resonance circuit 18 for recharging the snubber capacitors 12, 13 so as to enable turning on of the semiconductor devices of turn-off type of the current valves 1, 2 at low voltage thereacross, so-called soft-switching. The resonance circuit is constituted by an ARCP-circuit. How a circuit of this type operates is considered to be general knowledge, and reference is here made to interalia W McMurray, “Resonant snubbers with auxiliary switches”, IEEE IAS Conference Proceedings 1989, pages 829-834. The ARCP-circuit comprises more exactly an auxiliary valve 19 comprising auxiliary valve circuits 20, 21 connected in series, which each comprises a semiconductor device 22, 22′ of turn-off type, such as an IGBT, and a rectifying member 23, 23′ connected in anti-parallel therewith in the form of a diode, such as a free-wheeling diode. The semiconductor devices 22, 22′ of turn-off type of the two auxiliary valve circuits are arranged in opposite polarity with respect to each other. The ARCP-circuit also comprises an inductor 24 connected in series with the auxiliary valve circuits. This auxiliary valve 19 constitutes a bi-directional valve, which may be brought to conduct in one or the other direction. The function of the resonance circuit may be described briefly. When for example the current valve 2 conducts and the current flows from the phase output to this valve and this is controlled to turn off the current flowing into the phase output from the phase line is directly transferred to the two snubber capacitors 12, 13 and the voltage increases slowly across the current valve 2, so that the current through the semiconductor device 9 gets low before the voltage gets high and thereby the switching loss gets low. When the current direction with respect to the phase output is the same and instead the diode 10 in the main current valve 1 conducts and this shall be turned off the semiconductor device 12′ in the auxiliary valve circuit 21 is turned on. The load current in towards the phase output from the phase line is more and more transferred to flow through the inductor 24 having a large inductance and the current therethrough increases linearly. When the current through the diode 10 has reached zero, i.e. the entire load current flows through the inductor 24, the voltage of the phase output 14 will describe a sine function and swing over to get the same potential as the pole 4, so that the semiconductor device 9 in the main current valve 2 then may be turned on at zero voltage thereacross. It is shown how a separate second control arrangement 25 is arranged so as to control the semiconductor devices 22, 22′ of the two auxiliary valve circuits. It is a matter of course that the arrangement 17 and this second control arrangement 25 control the different semiconductor devices in an analogous way on switching when the current flows from the phase output out towards the alternating voltage phase line 15.

We will now restrict the description to what is happening when the diode 23 in the auxiliary valve circuit 20 is commutated to turn off, but the corresponding discussion is of course valid when turning the diode 23′ in the auxiliary valve circuit 21 off when the current has the opposite direction. Diodes being adapted for a rapid turning off by commutation are used in these types of circuits. When the semiconductor device 22′ is turned on and a current flows through the diode 23 and this is commutated to turn off by changing the direction of the current through the auxiliary valve circuit the commutation to turn off of the diode will as a consequence of the high inductance of the inductor 24 result in a high inductive overvoltage, i.e. a short time peak voltage, across the auxiliary valve circuit 19, i.e. across the diode 23. If no apparatus of the type defined in the introduction would be used for limiting this peak voltage this inductive over-voltage would destroy the diode. It is for this sake known, such as illustrated in FIG. 1, to arrange such an apparatus in the form of a so called RC-snubber member consisting of a resistor 46 and a capacitor 47 connected in series therewith. Such an RC-snubber member may limit the time derivative of the voltage increase across the diode when commutating this to turn off, so that the diode may be saved, as long as the diode has sufficient voltage blocking capability. However, a disadvantage of this solution is that comparatively large RC-snubber members, with a capacitor having a capacitance in the region of μF, are required, which results in considerable costs. Furthermore, the peak voltage value when commutating the diode 23 to turn off will still be comparatively high and the losses created, primarily at a later discharging of the capacitor when turning the auxiliary valves on, gets comparatively high. Furthermore, problems will arise due to oscillations between the inductor 24 and the capacitor 47.

Another known alternative is to instead arrange a so-called RCD-snubber member in parallel with the current valve (20). Thus, a diode is here connected in parallel with the resistor 46 or the diode is connected in series with a parallel connection of the capacitor 47 and the resistor 46. Also this solution results in high losses when commutating the diode to turn off and has other disadvantages, for example when connecting semiconductor devices and diodes connected in anti-parallel therewith in series in the current valve 20, as will be described below.

It is illustrated in FIG. 3 what is happening with the voltage across the diode 23 and the current therethrough when the diode 23 of the converter according to FIG. 1 is commutated to turn off. It is shown in the upper part of the diagram the current I in the valve versus the time t, while in the lower part the voltage U across the diode is shown versus the time t. It is shown how the reverse current a through the diode is developed over the time, and this will here be a maximum of for example 200 A, while the total current b through the diode and the RC-snubber member 46, 47 will reach a maximum value being twice as high, i.e. 400 A. The dashed line c shows a voltage U_{dc}, which may be 1200 V, while the maximum voltage d obtained across the valve will be for example 2800 V. The snubber capacitor 47 will restrict the time derivative of the voltage increase across the valve 20 when commutating the diode to turn off, while the resistor 46 will provide damping for the LC-resonance circuit formed through the inductor 24 and the capacitor 47. Thus, any instantaneous over-voltage when commutating to turn off is avoided, and the lower peak voltage, which however, is still comparatively high, will instead be displaced to a later moment. This peak voltage is depending upon U_{dc} and the magnitude of the inductance of the inductor 24 and the capacitance of the capacitor 47.

### SUMMARY OF THE INVENTION

The object of the present invention is to provide an electrical apparatus for peak voltage limitation of the type defined in the introduction, which at least partially finds a remedy to the inconveniences mentioned above of such apparatuses already known.

This object is according to the invention obtained by providing such an apparatus with means adapted to control the semiconductor device during the turning-off of the rectifying member so that the conductivity thereof increases.

A number of advantages may hereby be obtained. The semiconductor device being present in any case is in this way used as snubber member, so that no large snubber members in parallel with the rectifying member are needed anymore and thereby costs may be saved. It will also be possible to obtain a lower peak voltage across the rectifying member when turning it off. Since there is principally no problems to control the semiconductor device connected in anti-parallel with the rectifying member a controllable snubber member enabling a determination of the peak voltage across the rectifying member less dependent upon for example the pole voltage is in this way obtained for a converter of the type according to FIG. 1. It will hereby be possible to use a less expensive or alternatively another type of diode having a lower voltage blocking capability than otherwise would be the case, without any risk that this will be destroyed by said peak voltage. It has also turned out that it is possible to control the semiconductor device so that the maximum return current through the current valve gets low and also the losses when turning off (commutation for turning off) of the diode gets lower. The reliability of the function of the current valve is at the same time increased, since the turning off method of the rectifying member may in this way be controlled. To control the semiconductor device so that the conductivity thereof is increased may often be put equal to control it to turn on slightly.

According to a preferred embodiment of the invention said means are adapted to control the degree of conductivity of the semiconductor device when the rectifying member is turning on in dependence of the instantaneous magnitude of the voltage across the rectifying member. It may hereby be ensured that the time derivative of the voltage increase across the rectifying member gets as desired and for example a predetermined reference voltage wave shape is followed, which is the subject matter of another preferred embodiment of the invention.

The apparatus comprises advantageously members adapted to measure the voltage across the rectifying member and said means are adapted to consider voltage values so measured when controlling the semiconductor device.

According to another preferred embodiment of the invention the apparatus comprises members adapted to compare the voltage measured across the rectifying member with a reference voltage, and said means are adapted to control the semiconductor device in dependence of the result of this comparison. The voltage increase and also the final peak voltage across the rectifying member may in this way be controlled according to predetermined goals.

According to another preferred embodiment of the invention the apparatus is designed to limit the peak voltage across a rectifying member of a current valve with an IGBT as semiconductor device. This is particularly advantageous, since the turning on and the turning off of an IGBT are well controllable and IGBT is the semiconductor device presently mostly used in such current valves.

According to a preferred embodiment of the invention said means comprises a series connection of a capacitive and a resistive member between the gate and the collector of the IGBT and a negative current source connected to the gate, which is adapted to drain a predetermined current as soon as the voltage between the gate and the emitter of the IGBT exceeds a determined value, for example 0 V, and when this value is exceeded divert the share of the current above this predetermined current to the gate of the IGBT so as to increase the gate-emitter voltage thereof and bring the IGBT towards a state with a higher conductivity. A current will start to flow through the capacitive and the resistive member, such as a capacitor and a resistor, connected between the collector and the gate of the IGBT when the collector voltage of the IGBT increases. The amplitude of the current is determined by the time derivative of the collector voltage and the value of the capacitor, under the condition that the voltage drop across said resistance is small and may be neglected. This current is divided to flow to the negative current source and to flow into the gate. The charge flowing into the gate will raise the gate-emitter voltage until it reaches the threshold value at which the conductivity of the IGBT starts to increase. The time derivative of the increase of the collector voltage will then automatically be adjusted to a value determined in accordance with:

$$\frac{ⅆ {u}_{ce}}{ⅆ t} = \frac{{i}_{neg . str}}{{C}_{gc}}$$

Accordingly, by controlling the value of the negative current source during the over-voltage progress a desired voltage curve shape may be obtained. When the inductive over-voltage is terminated the voltage across the semiconductor device will return to the pole voltage in FIG. 1. This results in a current flowing in the opposite direction through the link between the gate and the collector and it will thereby discharge the gate, since the current source cannot deliver this current. This means that the conductivity of the IGBT will decrease, so that the semiconductor device gets a low leakage current in the resting position thereof.

According to another preferred embodiment of the invention, which constitutes a further development of the embodiment last mentioned, said members for controlling the predetermined current level of the current source is adapted to achieve such controlling between at least two discrete values and at voltages across the rectifying member below a predetermined level to have a first higher current value of the current source and when exceeding the predetermined level of the voltage across the rectifying member change to a second lower value of the current which the current source is adapted to drain. At lower voltages across the rectifying member a more rapid voltage increase will in this way take place, while at higher voltages the voltage increase will be slower and even in principle nearly zero. This is desired in many applications (see below).

According to another preferred embodiment of the invention said control member is adapted to control the current of the current source to have a high level until the voltage across the rectifying member has exceeded a predetermined value. The fact is that it is advantageous to wait to in a substantial degree limit the time derivative of the voltage across the rectifying member until a certain voltage value has been obtained, since such a limitation before said value of the voltage has been obtained will mean that the current through the inductor increases and thereby the total losses in the valve increase. This means that it is advantageous to let a more powerful limitation of the time derivative of the voltage across the rectifying member wait until said voltage value has been exceeded.

According to another preferred embodiment of the invention the apparatus comprises a RC-snubber member connected in parallel with the rectifying member of the current valve. Such a RC-snubber member may be made with a comparatively small capacitor and arranged for rapidly suppressing high frequency oscillations of the circuit.

According to another preferred embodiment of the invention the apparatus is adapted to limit the peak voltage across the rectifying members of a current valve with a series connection of semiconductor devices and rectifying members connected in anti-parallel therewith, and the apparatus comprises said means adapted to individually control the semiconductor device belonging to each individual rectifying member to turn on at least slightly when the rectifying member is turning off. By the fact that the invention in this way enables an active control of the peak voltage at each position and the peak voltage is not controlled by for example stray capacitances to ground, by differences in the maximum reverse current through the diodes or by tolerances of the snubber capacitors, a protection of each semiconductor device against high peak voltages may reliably and safely be obtained. Furthermore, the losses get lower than when using the RC- or RCD-circuits already known as snubber members, since in a RC-circuit the capacitor is charged and the energy is converted into heat each time, while in a RCD-circuit at such a series connection differently much energy will be stored in the capacitors for different rectifying members, and this energy has also to be converted into heat and causes losses when the valve switches.

According to another preferred embodiment of the invention the current valve is a part of a voltage stiff converter adapted to convert alternating voltage into direct voltage and conversely by being a part of a converter circuit of ARCP-type for recharging snubber capacitors of other main current valves located on both sides of a phase output for enabling turning on of semiconductor devices of turn-off type of the main current valves at a low voltage thereacross by that. This constitutes a particularly advantageous application of the apparatus according to the invention, since in such a case a comparatively large inductance is arranged in series with the rectifying member and in the same circuit as this when turning that off. Another advantageous use is for limiting the peak voltage across a rectifying member of a said current valve being a part of a converter belonging to an arrangement for driving an electric motor. A comparatively high inductance in series with a rectifying member (diode) when this is to be turned off is also present in converters in such motor driving assemblies, and an apparatus according to the invention is then very advantageous.

The invention relates to a method for limiting the peak voltage across the rectifying member of a current valve arranged in a circuit with a substantial inductance and having at least one controllable semiconductor device and at least one said rectifying member connected in anti-parallel therewith when the rectifying member is turning off according to the appended independent method claim.

The advantages of this method and the embodiments of the method defined in the appended dependent claims appear without any doubt from the discussion above of preferred embodiments of the apparatus according to the invention.

The invention also relates to a computer program product as well as a computer readable medium according to the corresponding appended claims. It is easily understood that a method according to the invention defined in the appended set of method claims is well suited to be carried out through program instructions from a processor which may be influenced by a computer program provided with the program step in question.

Further advantages as well as advantageous features of the invention appear from the other dependent claims.

### BRIEF DESCRIPTION OF THE DRAWINGS

With reference to the appended drawings, below follows a specific description of preferred embodiments of the invention cited as examples. In the drawings:

FIG. 1 is a simplified circuit diagram of a converter provided with an apparatus for peak voltage limitation according to the prior art,

FIG. 2 is a view corresponding to FIG. 1 of a converter provided with an apparatus according to a preferred embodiment of the invention and very schematically indicated,

FIG. 3 is a diagram illustrating the development of the current through a diode and through the entire current valve to which the diode belongs and the associated snubber member and the voltage across the diode versus time when this diode of the converter according to FIG. 1 is turning off,

FIG. 4 is a diagram corresponding to the diagram according to FIG. 3 for the converter according to the invention shown in FIG. 2,

FIG. 5 is a simplified circuit diagram illustrating a part of a converter according to FIG. 2 with an apparatus according to a first preferred embodiment of the invention,

FIG. 6 is a simplified circuit diagram of a part of a converter according to FIG. 2 provided with an apparatus according to a second preferred embodiment of the invention,

FIG. 7 is a view corresponding to FIG. 6 of a converter provided with an apparatus according to a third preferred embodiment of the invention,

FIG. 8 is a view corresponding to FIG. 6 of a converter provided with an apparatus according to a fourth preferred embodiment of the invention, and

FIG. 9 is a diagram corresponding to FIGS. 3 and 4 for the current valve of the converter according to FIG. 8, but the control current I versus time t of a current source being a part of the apparatus has here also been drawn up.

### DETAILED DESCRIPTION OF PREFERRED EMBODIMENTS OF THE INVENTION

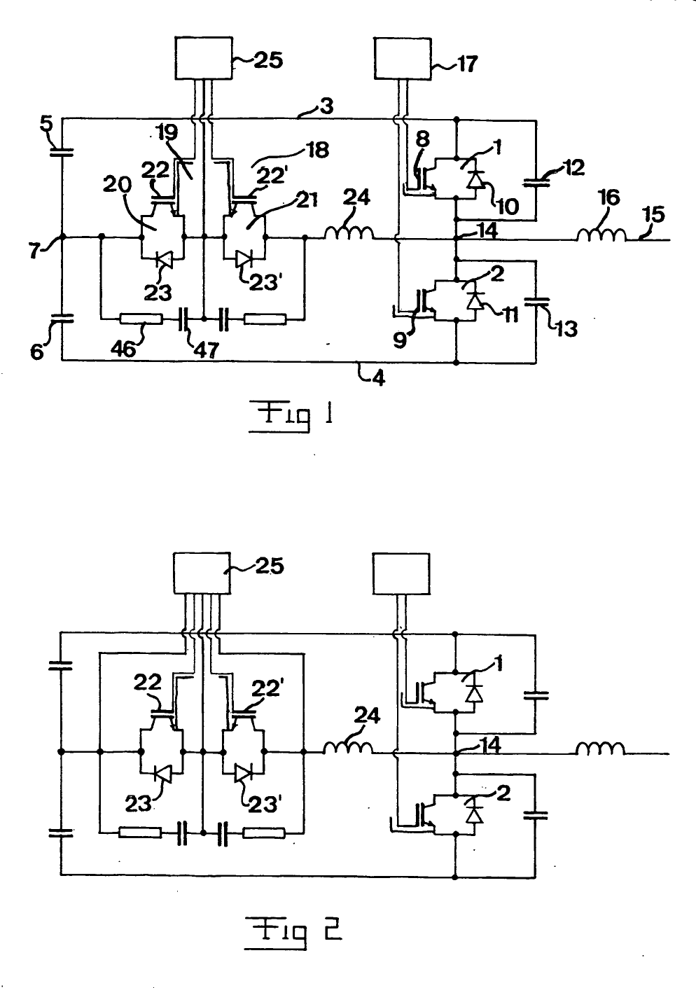

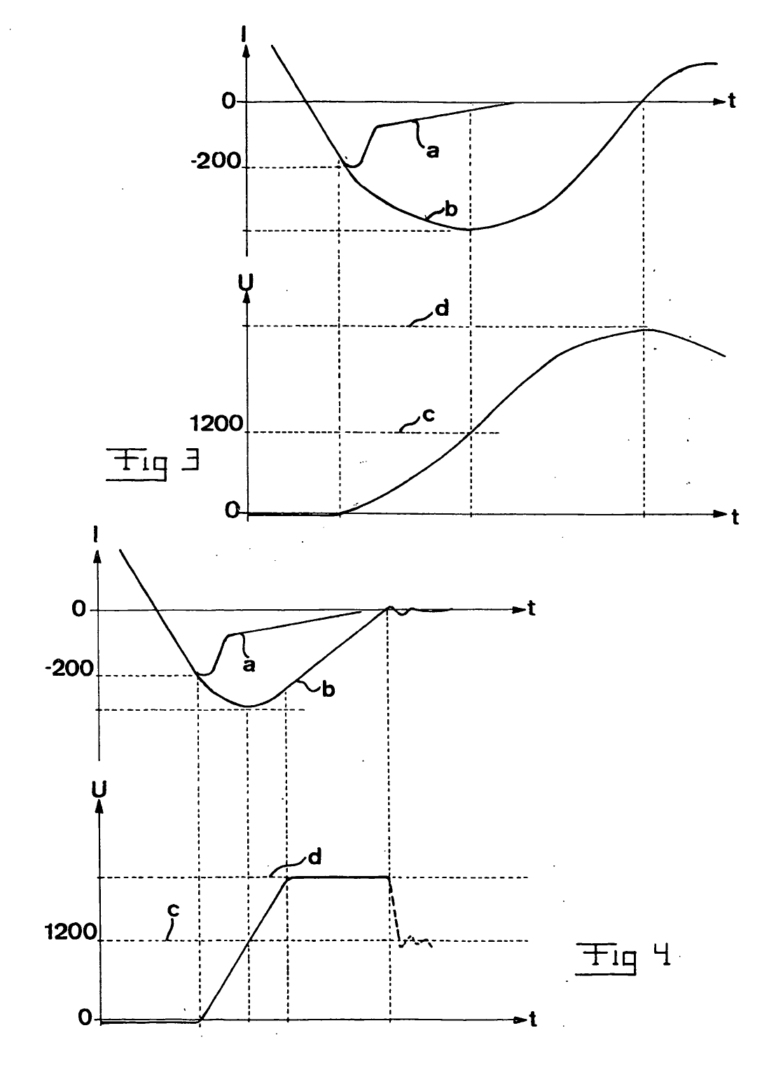

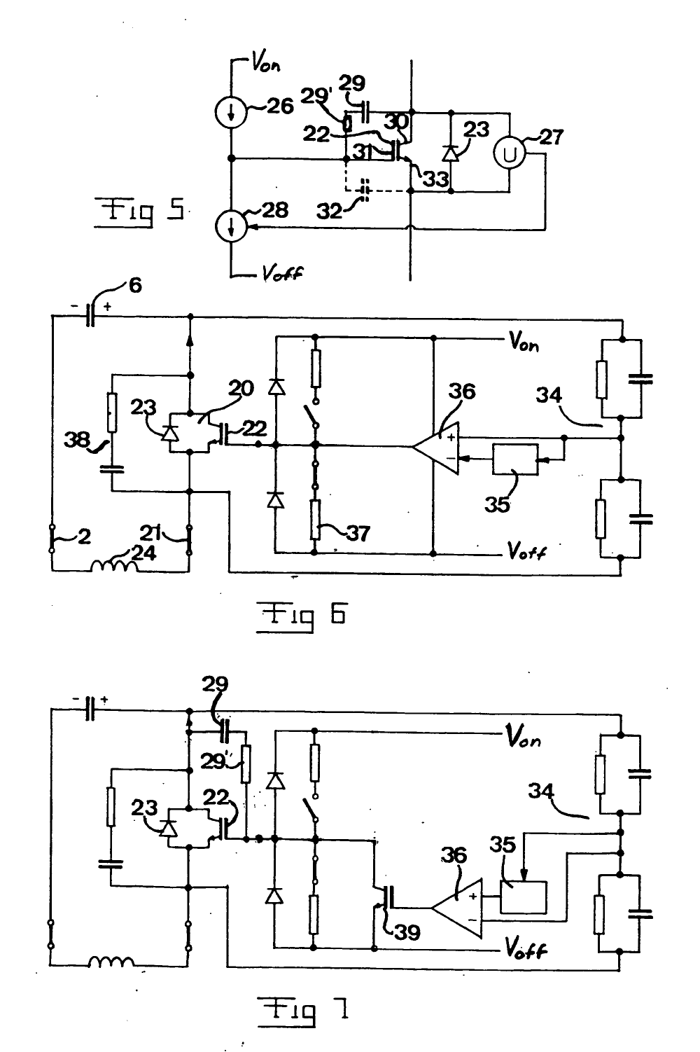

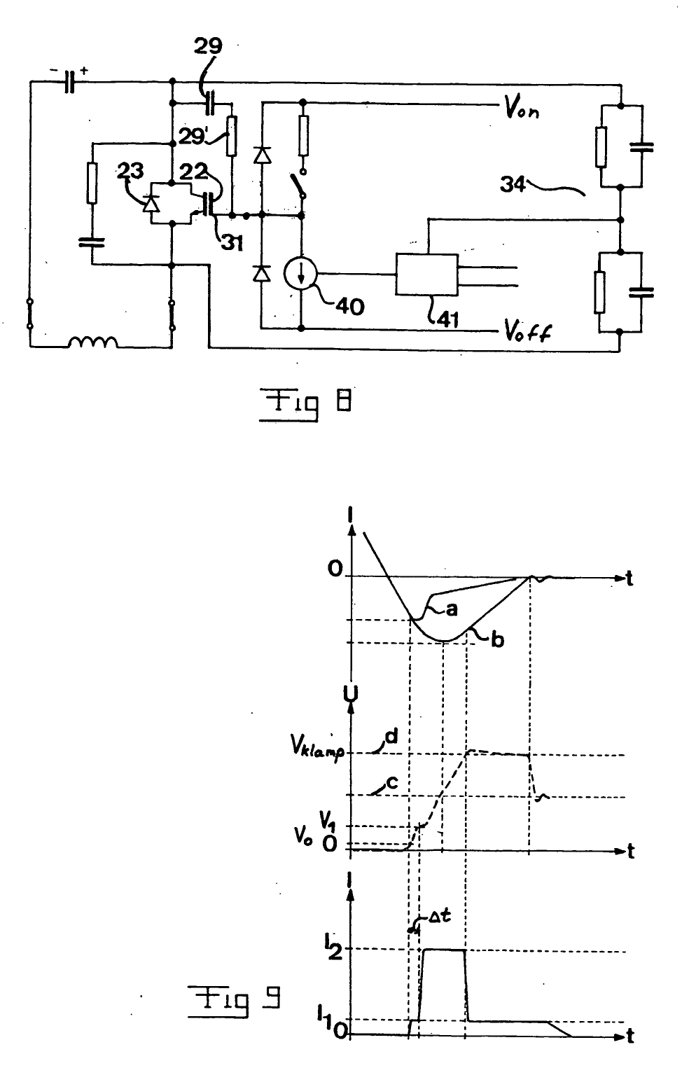

The basic idea of the invention has very schematically been shown in FIG. 2 by showing there how the second control arrangement 25 is modified and connected in another way than the control arrangement 25 of the converter according to FIG. 1, more exactly in such a way that it comprises means adapted to control the semiconductor device connected in anti-parallel with the rectifying member 23 or 23′ when this is turning off so that the conductivity increases. What this means in practice is shown in the diagram in FIG. 4, which corresponds to the diagram according to FIG. 3. The following data and properties may be valid for this: We assume that U_{dc}=1200 volts, the maximum reverse current in the diode 23 Iᵣₘ=200 A, the inductance of the inductor 24 L=8 μH (di/dt=−1200 V/8 μH=−150 A/μs) and the diode turns rapidly off. The IGBT 22 in anti-parallel will limit dV_{ce}/dt (V_{ce}=the collector emitter voltage of the IGBT) to a certain pre-determined value, such as for example 1 kV/μs. A somewhat idealized wave shape is shown in FIG. 4. The collector-emitter voltage will reach U_{dc} at a point of time of 1,2 μs after Iᵣₘ with a total maximum reverse current in the valve of approximately 300 A. At another predetermined value, which in this example is V_{ce}=V_{clamp}=2.0 kV, the voltage across the anti-parallel IGBT is clamped at a valve current of 260 A. The valve current is reduced to zero with a di/dt=(V_{clamp}−U_{dc})/L=100 A/μs during a period of time of 2.6 μs. The total energy consumed in the diode and in the anti-parallel IGBT may be calculated to be about 1.2 J, which is less than in the apparatus already known according to FIG. 1. Another advantage is that the peak voltage has been reduced to 2.0 kV and that the clamping voltage now is independently of the pole voltage U_{dc}. By increasing dV_{ce}/dt to a higher value or by increasing the clamping voltage the turning-off losses may be reduced further. If the diode can take an increase of the peak voltage to 2300 volts this will result in a possibility to more rapidly reduce the current through the inductor 24 and the turning-off losses thereby get lower. The current through the inductor 24 will not be influenced in reducing direction until the voltage across the diode 23 in the reverse direction thereof has exceeded U_{dc}. Thus, the size of the difference of the instantaneous voltage and U_{dc} will decide how rapidly the current through the inductor may be reduced to zero.

In FIG. 5 it is very schematically illustrated how an apparatus according to the invention may be built in the practice. A controlled current source 26 used for the normal turning-on of the IGBT 22 is shown in this figure, but this has nothing to do with the function of the apparatus according to the invention. It is schematically illustrated how a member 27 is adapted to measure the voltage across the diode 23 and send information thereabout to a negative current source 28, the function of which will be explained further below. The member 27 may be designed in many different ways apparent to a person with skill in the art.

It is also illustrated how a capacitor 29 with a capacitance C and a resistor 29′ are arranged in series between the collector 30 and the gate 31 of the IGBT. The negative current source 28 is connected between the gate and the emitter. The internal gate-emitter-capacitance in the IGBT 22 is indicated through a capacitor 32. The current source is adapted to drain a predetermined current thereto within the voltage range thereof (Voff<Vge<Von). When the outer feeding circuit creates a positive voltage derivative when the diode 23 is turning off a current will flow through 29 and 29′. This current is distributed on a current source 28, to which 2 A flows, and the rest of the current flows to the gate of the IGBT so as to increase the gate-emitter voltage thereof for increasing the conductivity of the semiconductor device when the gate reaches the threshold voltage thereof.

The function of the apparatus according to FIG. 5 is as follows: when the diode 23 is turned off a voltage will start to be built up thereacross. This voltage will mainly correspond to the voltage between the collector 30 and the gate 31 of the IGBT and drive the current through the capacitor 29 and the resistor 29′ towards the current source 28. The magnitude of this current is controlled by the formula

$$I = C \frac{ⅆ U}{ⅆ t} ,$$

where U is the voltage between the collector and the gate of the IGBT and C is the capacitance of the capacitor 29. When the predetermined level of the current source, for example 2 A, is exceeded the share of the current thereabove will be diverted to the gate 31 of the IGBT, so that the capacitance 32 will raise the voltage between the gate 31 and the emitter 33 of the IGBT. When this voltage reaches above the threshold voltage of the IGBT the conductivity of the IGBT will increase and a part of the return current will start to flow through the IGBT. When the conductivity of the IGBT increases the current through the capacitor 29 will assume substantially the value determined by the current source, in which the gate-emitter voltage is kept substantially constant to the value needed for obtaining a desired conductivity. The voltage increase across the diode will in this way take place in a controlled way with the dV_{ce}/dt as indicated in FIG. 4. When then a certain voltage, namely V_{clamp} is reached, the member 27 informs the current source 28 thereof, whereupon this is controlled to drain a considerably lower current, such as for example 0.2 A, which means that the dV_{ce}/dt will be considerably lower, such as for example be changed from 500 V/μs to 50 V/μs, which in the practice means that the voltage across the diode 23 will be substantially constant until the inductor 24 does not feed any current any longer and the IGBT 22 will thereby turn off by itself. When this takes place the collector voltage of the IGBT falls to the pole voltage U_{dc}, such as indicated through a dashed line in FIG. 4. When the collector voltage falls down a current will flow from the gate to the collector through the capacitor 29 discharging the gate and thereby reducing the conductivity of the IGBT to a much lower value.

It would of course be well possible to build in a number of different levels in the current source 28 for changing the control thereof in dependence of the voltage measured by the member 27. This may be done so that the total turning-off losses are minimized.

An apparatus according to another preferred embodiment of the invention is schematically illustrated in FIG. 6. The case of turning-off the diode in the valve circuit 20 is also shown here. The valve circuit 21 is conducting and the main current valve 2 has been turned on. The diode 23 conducts a current starting to flow in the reverse direction. The IGBT 22 is turned off. A voltage divider 34 is used for measuring the voltage across the valve circuit 20, i.e. the diode 23. As soon as the diode 23 starts to take voltage a reference ramp generator 35 is started, which is triggered by the fact that the collector-emitter voltage measured by the voltage dividers 34 is higher than a reference voltage, preferably 0 volt. A time-depending reference voltage is thereby generated and compared in an amplifier 36 with the voltage measured across the diode 23. As soon as the measured voltage is higher than the reference voltage the amplifier 36 starts to increase the conductivity of the IGBT 22 so as to bring the measured voltage to follow the reference voltage. The amplifier 36 may deliver sufficient current for raising the gate-emitter voltage of the IGBT 22, so that the conductivity of the IGBT increases. The resistor 37, which tries to keep the IGBT 22 turned off, has in this case a comparatively high impedance, which allows the amplifier to increase the voltage of the gate of the IGBT to a value at which the conductivity of the IGBT increases. As soon as the voltage measured by the voltage divider 34 is lower than the reference voltage delivered by the generator 35 the gate voltage will again be reduced to Voff and the conductivity of the IGBT gets low. It is also illustrated that a small RC-snubber member 38 with a capacitance in the order of 50 nF is used so as to suppress oscillations in the MHz-region in the circuit.

An apparatus according to another preferred embodiment of the invention is schematically illustrated in FIG. 7, and the description will here be restricted to the differences thereof with respect to the embodiment according to FIG. 6. The current to the gate is in this embodiment controlled through a capacitor 29 between the gate and the collector of the IGBT, which acts as a current source (as in the embodiment according to FIG. 5) as long as the collector voltage increases. This capacitor 29 will try to increase the conductivity of the IGBT as soon as the collector-emitter voltage of the IGBT increases. For avoiding that the IGBT is turned on too much there is also a negative current source formed by the amplifier 36 and the transistor 39, controlled thereby, and through which the value of the current that will be drained from the gate will be controlled according to the measured fault of the measured collector-emitter voltage with respect to the reference voltage wave shape. As soon as the reference voltage is higher than the voltage measured by the voltage dividers 34 the amplifier 36 starts to increase the conductivity of the transistor 39, so that the gate-emitter voltage is limited to a suitable value so as to increase the collector-emitter voltage of the IGBT so that this follows the reference voltage.

An apparatus according to a further preferred embodiment of the invention is illustrated in FIG. 8 and this constitutes a simplification of the embodiment according to FIG. 7. No reference voltage generator is present in this embodiment, but a voltage limited negative current source 40 is instead used, which preferably may be controlled to drain either a low predetermined current or a high predetermined current. Reference is now also made to FIG. 9. When turning off the low current is initially drained by the current source 40, which is controlled by the control member 41. When the collector voltage starts to increase the capacitor 29 will feed a current to the gate 31 of the IGBT. The capacitance of the capacitor is sufficiently large and the low predetermined current value is sufficiently low for turning the IGBT on and limit the time derivative of the voltage across the diode 23 to a voltage V₁ according to FIG. 9. The voltage dividers will now measure when the collector-emitter voltage is higher than V₀, and after a time delay of Δt the current source 40 will instead drain a current according to the higher current value. When dimensioning the capacitor 29 and the value of the current source according to FIG. 9 correctly the IGBT will actively adjust the conductivity when the collector-emitter voltage has reached the value V₁. When the collector-emitter voltage is equal to V₁ the gate-emitter voltage of the IGBT is sufficiently high for making the IGBT able to limit the time derivative of the voltage across the diode 23. At another voltage, namely when the voltage across the diode is equal to V_{clamp}, it is desired to turn the IGBT on even more for bringing it to clamp the voltage on this level. The current source 40 is at this voltage allowed to return to the low current value being so low that the voltage across the diode 23 will not increase remarkably during the clamping period. The first limitation according to V₁ is in the first place for ensuring that the gate of the IGBT is located close to the threshold voltage when the maximum voltage level V_{clamp} is exceeded. This reduces the delay in the control loop. So as to manage the series connection with different components it is extremely important that this active control is rapid and individual. The step between low and high current should be as large as possible for compensating differences between different component data so as to enable the series connection.

The invention is of course not in any way restricted to the preferred embodiments described above, but many possibilities to modifications thereof will be apparent to a person with ordinary skill in the art without departing from the basic idea of the invention as defined in the claims.

The current source shown in FIG. 8 may for example instead be realized through a variable resistor which may have a low resistance value when the collector-emitter voltage of the IGBT increases and a higher value so as to clamp the collector-emitter voltage.

1. An electrical apparatus for limiting the peak voltage across a rectifying member of a current valve arranged in a circuit having a substantial inductance and having at least one controllable semiconductor device and at least one said rectifying member connected in anti-parallel therewith when turning off the rectifying member, characterized in that it comprises means adapted to control the semiconductor device so that the conductivity thereof is increased during the turning off of the rectifying member.

2. An apparatus according to claim 1, wherein said means are adapted to control the degree of conductivity of the semiconductor device when the rectifying member is turning off in dependence of the instantaneous magnitude of the voltage across the rectifying member.

3. An apparatus according to claim 2, wherein means are adapted to control the voltage across the rectifying member according to a predetermined reference voltage wave shape through controlling the degree of conductivity of the semiconductor device when the rectifying member is turning off.

4. An apparatus according to claim 2, wherein it comprises members adapted to measure the voltage across the rectifying member and said means are adapted to consider voltage values so measured when controlling the semiconductor device.

5. An apparatus according to claim 4, wherein it comprises members adapted to compare the voltage measured across the rectifying member with a reference voltage, and that said means are adapted to control the semiconductor device in dependence of the result of this comparison.

6. An apparatus according to claim 5, wherein said means are adapted to control the semiconductor device towards an increasing conductivity when the voltage measured is higher than the reference voltage and control the semiconductor device towards a lower conductivity when the voltage measured is lower than the reference voltage.

7. An apparatus according to claim 1, wherein it is designed to limit the peak voltage across a rectifying member of a current valve having an IGBT (Insulated Gate Bipolar Transistor) as semiconductor device.

8. An apparatus according to claim 7, wherein said means comprise a series connection of a capacitive and a resistive member between the gate and the collector of the IGBT and a negative current source connected to the gate and adapted to drain a predetermined current as soon as the voltage between the gate and the emitter of the IGBT exceeds a determined value and when this value is exceeded divert the share of the current above this predetermined current to the gate of the IGBT so as to increase this gate-emitter voltage and bring the IGBT towards a state of a higher conductivity.

9. An apparatus according to claim 8, wherein the current source is controllable, and that the apparatus comprises members adapted to control said predetermined level of the current drained by the current source so as to control the time derivative of the voltage increase across the IGBT when the rectifying member is turning off.

10. An apparatus according to claim 9, wherein said members for controlling the predetermined current level of the current source is adapted to achieve such controlling between at least two discrete values and at voltages across the rectifying member below a predetermined level to have a first higher current value of the current source and when exceeding the predetermined level of the voltage across the rectifying member change to a second lower value of the current which the current source is adapted to drain.

11. An apparatus according to claim 10, wherein the first higher current value is substantially higher than the second lower current value, preferably at least five times higher.

12. An apparatus according to claim 9, wherein the current control members comprise a transistor adapted to be controlled for controlling the current of the current source.

13. An apparatus according to claim 9, wherein the current control members comprise a resistor with a variable resistance and members adapted to vary the resistance of the resistor for varying the current of the current source.

14. An apparatus according to claim 9, wherein said control member is adapted to control the current of the current source to have a high level until the voltage across the rectifying member has exceeded a value above which it will effect a reduction of the current through said inductance.

15. An apparatus according to claim 9, wherein a capacitor is arranged between the collector and the gate of the IGBT and in series with the collector and the current source.

16. An apparatus according to claim 1, wherein a RC-snubber member is connected in parallel with the rectifying member of the current valve.

17. An apparatus according to claim 1, wherein it is adapted to limit the peak voltage across the rectifying member of a current valve having a series connection of semiconductor devices and rectifying members connected in anti-parallel therewith, and that the apparatus comprises said means adapted to individually control the semiconductor device belonging to each individual rectifying member to turn on at least slightly when the rectifying member is turning off.

18. An apparatus according to claim 1, wherein it is adapted to limit the peak voltage across a rectifying member in the form of a diode when the latter is turned off.

19. An apparatus according to claim 1, wherein it is adapted to limit the peak voltage across a rectifying member of a said current valve included in a converter.

20. An apparatus according to claim 19, wherein the current valve is a part of a voltage stiff converter adapted to convert alternating voltage into direct voltage and conversely.

21. An apparatus according to claim 20, wherein said converter is a part of a plant for transmitting electric power in the form of high voltage direct current (HVDC).

22. An apparatus according to claim 20, wherein said current valve is a part of a resonance circuit for recharging snubber capacitors of other main current valves located on both sides of a phase output of the converter so as to thereby enable turning on of semiconductor devices of turn-off type of the main current valves at a low voltage thereacross.

23. An apparatus according to claim 22, wherein the resonance circuit is constituted by an ARCP-circuit (Auxiliary Resonant Commutation Pole).

24. An apparatus according to claim 23, wherein said current valve, in which the peak voltage across a rectifying member shall be limited when the rectifying member is turning off, is a part of a so called auxiliary valve circuit in the ARCP-circuit.

25. An apparatus according to claim 24, wherein the converter has an auxiliary valve comprising at least one set of two said auxiliary valve circuits connected in series, each of which comprises a semiconductor device of turn-off type and a rectifying member connected in anti-parallel therewith, said semiconductor devices of turn-off type of the two auxiliary valve circuits being arranged in opposite polarity with respect to each other, and that the ARCP-circuit also comprises an inductor connected in series with said set of auxiliary valve circuits.

26. An apparatus according to claim 19, wherein it is adapted to limit the peak voltage across a rectifying member of a said current valve being a part of a converter belonging to an arrangement for driving an electric motor.

27. A method for limiting the peak voltage across a rectifying member of a current valve arranged in a circuit having a substantial inductance and having at least one controllable semiconductor device and at least one said rectifying member connected in anti-parallel therewith when turning off the rectifying member, characterized in that the semiconductor device is during the turning off of the rectifying member controlled towards an increased conductivity for limiting the voltage increase across the rectifying member.

28. A method according to claim 27, wherein the degree of turning on of the semiconductor device at turning off of the rectifying member is controlled in dependence of the instantaneous magnitude of the voltage across the rectifying member.

29. A method according to claim 28, wherein the voltage across the rectifying member of the current valve is controlled according to a predetermined reference voltage wave shape when the rectifying member is turning off.

30. A method according to claim 27, wherein it is the peak voltage across a rectifying member of a current valve having an IGBT as semiconductor device that is limited, and that the current limitation takes place by diverting a current from the collector of the IGBT until a predetermined level has been reached for the current and when this level is exceeded the share of the current above this level is diverted to the gate of the IGBT so as to increase the gate-emitter voltage thereof and influence the IGBT towards an increased conductivity.

31. A method according to claim 30, wherein said predetermined level of the current is controlled so as to control the time derivative of the voltage increase across the IGBT when the rectifying member is turning off.

32. A computer program product adapted to be loaded directly into the internal memory of a computer and comprising software code portions for instructing a processor to carry out the steps according to claim 27, when the product is run on a computer.

33. A computer program product according to claim 32, provided at least partially over a network as the Internet.

34. A computer readable medium having a program recorded thereon adapted to make a computer control the steps according to claim 27.
